(19) United States
(12) Patent Application Publication
(10) Pub. No.: US 2026/0203605 A1
(43) Pub. Date: Jul. 16, 2026

(54) USING A PREDICTIVE MODEL TO TEST AND MONITOR APPLICATION SYSTEMS

(71) Applicant: Dell Products L.P., Round Rock, TX (US)

(72) Inventors: Pradyumna Kumar Prusty, JAJPUR (IN); Kailash Talreja, MUMBAI (IN); Saurabh Jha, Austin, TX (US)

(21) Appl. No.: 19/023,241

(22) Filed: Jan. 15, 2025

(51) Int. Cl. G06N 5/022

(52) U.S. Cl. CPC G06N 5/022

(57) ABSTRACT

The technologies described herein are generally directed to use a predictive model to test and monitor application systems. For instance, a system can receive data from operation of an application system, resulting in received data. The system may further include, based on the received data, identifying fault data representative of a fault scenario, with at least one layer of layers of an architecture of the application system being subject to injection of a fault. Further, the system may include, based on a model of operation of the application system, predicting a result of the injection of the fault, resulting in a predicted result. The system may further include, based on a difference between an actual result of the injection and the predicted result, adjusting the injection of the fault.

### BACKGROUND

Modern approaches to testing applications may utilize approaches where faults are introduced into the operation of services and results are analyzed. In some circumstances, tested applications may utilize multiple architectural layers, microservices, containerized elements, and distributed architectures.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include receiving, by a computing system including one or more processors, data from operation of an application system, resulting in received data. The method may further include, based on the received data, identifying fault data representative of a fault scenario, with at least one layer of layers of an architecture of the application system being subject to injection of a fault. Further, the method may include, based on a model of operation of the application system, predicting, by the computing system, a result of the injection of the fault, resulting in a predicted result. The method may further include, based on a difference between an actual result of the injection and the predicted result, adjusting, by the computing system, the injection of the fault.

Additionally or alternatively, the model of operation of the application system was trained based on historical incident data of the application system and historical telemetry data applicable to the application system, and the predicting of the result employs conformal prediction of the result. Additionally or alternatively, the predicted result may be associated with a confidence level.

Additionally or alternatively, the method may further include, based on the confidence level, changing, by the computing system, the injection of the fault resulting in an updated confidence level for the predicted result that is different from the confidence level. Additionally or alternatively, the method may further include, based on a second model of operation of the application system, applying, by the computing system, conformal prediction to respective received data received by the computing system, the applying of the conformal prediction includes generating respective confidence scores for the respective received data, the predicting of the result may be further based on a confidence score of the respective confidence scores, and the confidence score may be correlated to the predicted result.

Additionally or alternatively, the method may further include, based on the respective confidence scores, filtering, by the computing system, the received data from the identifying of the fault data representative of the fault scenario. Additionally or alternatively, the second model was trained based on historical information that includes normal events and abnormal events of the application system. Additionally or alternatively, the method may further include, based on the respective confidence scores, categorizing the respective received data into different reliability levels. Additionally or alternatively, the received data was collected from the at least one layer of the layers of the architecture of the application system, and the layers may include at least one of, a hardware layer, a network layer, an application layer, or a service layer.

Additionally or alternatively, the predicted result may include predicted results for multiple layers of the layers of the architecture of the application system. Additionally or alternatively, the predicted results for the multiple layers may include an effect at a layer of the multiple layers that was propagated to the layer by another layer of the multiple layers other than the layer. Additionally or alternatively, propagation of the effect was caused by an interdependency between the layer and the other layer, and the predicted result may be further based on the interdependency.

Additionally or alternatively, the injection of the fault may include a first injection of a first fault at a first layer of the multiple layers, and a second injection of a second fault at a second layer of the multiple layers, and the predicted results may include effects, to the application system, from occurrence of a combination of the first fault and the second fault. Additionally or alternatively, the adjusting of the injection of the fault may include at least one of changing an intensity of the fault, selecting a different fault other than the fault, or selecting a new combination of the layers for the injection of the fault. Additionally or alternatively, the application system may include a cloud-based application system.

An example system can operate as follows. At least one memory may store computer executable instructions, and at least one processor may be configured to process the computer executable instructions that, when executed by the at least one processor, facilitate performance of operations. The operations may include communicating, to a testing system, training data including historical data generated based on an operation of the computing system. The operations may further include receiving, from the testing system, a test instruction configured to cause an error in an absence of a fault, with the error including events occurring at a first tier of a tiered infrastructure of the computing system and a second tier of the computing system. The operations may further include, communicating, to the testing system, result data based on the test instruction. The operations may further include receiving, from the testing system, a modified test instruction, with the modified test instruction being based on the training data.

Additionally or alternatively, the modified test instruction is based on a conformal prediction of the result data that was generated based on a model that was trained based on the training data. Additionally or alternatively, the modified test instruction was generated based on a confidence level of the conformal prediction, and the confidence level was determined based on the model. Additionally or alternatively, the result data may include a first event, occurring at the first tier, that is based on a cascading of an effect of a second event caused by the test instruction at the second tier.

An example non-transitory machine-readable medium may include executable instructions that, when executed by at least one processor, facilitate performance of operations. The operations may include receiving log data associated with a cloud-based system, resulting in received log data. The operations may further include, based on the received log data, identifying, by the computing system, a first testing plan with predicted results of the first testing plan having at least a threshold likelihood of occurring at the cloud-based system. The operations may further include monitoring implementation of the first testing plan at multiple architectural layers of the cloud-based system, resulting in first testing results. The operations may further include, based on the first testing results, implementing a second testing plan generated based on second results of the second testing plan having at least the threshold likelihood of occurring at the cloud-based system. Additionally or alternatively, the second testing results are based on a monitoring of the implementing of the second testing plan at the multiple architectural layers of the cloud-based system, and the operations further include, based on the first testing results and the second testing results, modifying a configuration of the cloud-based system.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate using a predictive model to test and monitor application systems, in accordance with one or more embodiments;

FIG. 2 is an architecture diagram of an example system that can facilitate using a predictive model based on application data to test and monitor application systems, in accordance with one or more embodiments;

FIG. 3 includes a diagram that illustrates an example system that can facilitate using a predictive model to test and monitor application systems, in accordance with one or more embodiments;

FIG. 4 includes a diagram that illustrates an example system that can facilitate using a conformal prediction-drives model to dynamically perform and monitor fault injection testing, in accordance with one or more embodiments;

FIG. 5 includes a diagram that illustrates an example system that can facilitate using a predictive model to test and monitor multiple application layers in a cloud-based system, in accordance with one or more embodiments;

FIG. 6 depicts example pseudocode that can be used by embodiments to use a predictive model to test and monitor application systems, in accordance with one or more embodiments;

FIG. 7 depicts example pseudocode that can be used by embodiments to use a predictive model to test and monitor application systems, in accordance with one or more embodiments;

FIG. 8 depicts example pseudocode that can be used by embodiments to use a predictive model to test and monitor application systems, in accordance with one or more embodiments;

FIG. 9 depicts example pseudocode that can be used by embodiments to use a predictive model to test and monitor application systems, in accordance with one or more embodiments;

FIG. 10 depicts a flow diagram representing example operations of an example method that can facilitate using a predictive model to test and monitor application systems, in accordance with one or more embodiments;

FIG. 11 depicts an example system that can facilitate using a predictive model to test and monitor application systems, in accordance with one or more embodiments;

FIG. 12 depicts an example non-transitory machine-readable medium that can include executable instructions that, when executed by a processor of a system, can facilitate using a predictive model to test and monitor application systems, in accordance with one or more embodiments;

FIG. 13 is a schematic block diagram of a system with which the disclosed subject matter can interact; and

FIG. 14 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the operation, accuracy, and usefulness of application testing systems can be improved, e.g., by combining collected data prioritized based on reliability with real-time predictions based on confidence scoring. One or more embodiments described herein are not abstract concepts; rather, they provide technical solutions to technical problems associated with identifying errors and inefficiencies in the operation of applications using computer systems, providing technical solutions to technical problems that are inextricably tied to computer systems. For example, generally speaking, one or more embodiments may combine dynamic fault injection, predictive modeling, and confidence-based observability to improve the resilience, reliability, and efficiency of complex application systems. Moreover, implementations described herein can provide these solutions in a manner that cannot reliably be performed by a human or even a plurality of humans, e.g., complex fault injection scenarios may require complex analysis at a pace beyond performance by manual operations.

Example embodiments of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

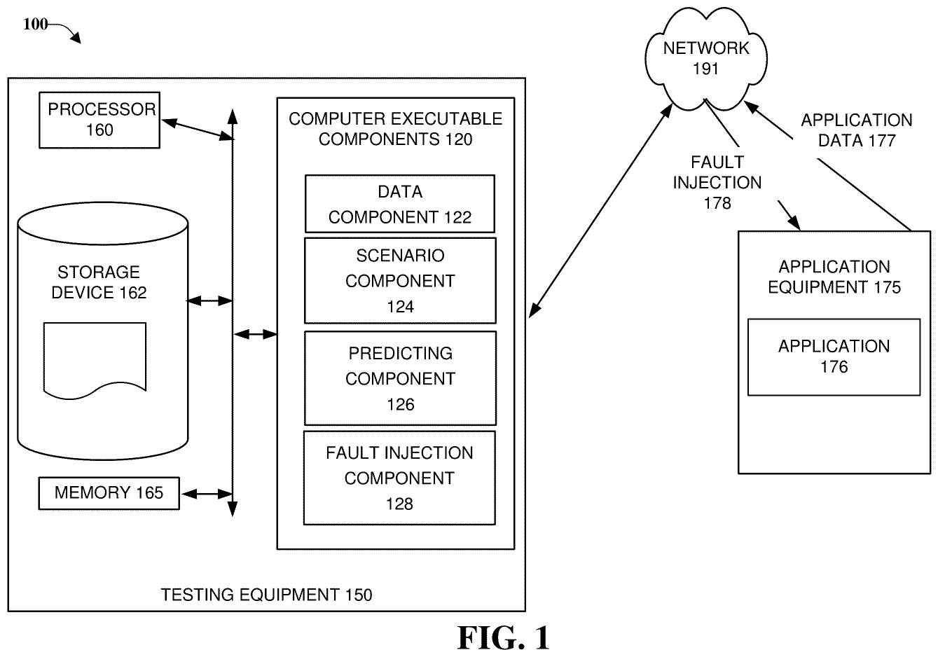

FIG. 1 is an architecture diagram of an example system 100 that can facilitate using a predictive model to test and monitor application systems, in accordance with one or more embodiments. For purposes of brevity, description of like elements and/or processes employed in other embodiments is omitted. As depicted, system 100 includes testing equipment 150 connected, via network 191, to application equipment 175. Testing equipment provides fault injection 178 to application equipment 175, which provides application data 177 to testing equipment 150.

As depicted, testing equipment 150 can include memory 165 that can store one or more computer and/or machine readable, writable, and/or executable components 120 and/or instructions. In embodiments, testing equipment 150 can further include processor 160. In one or more embodiments, computer executable components 120, when executed by processor 160, can facilitate performance of operations defined by the executable component(s) and/or instruction(s). Computer executable components 120 can include data component 122, scenario component 124, predicting component 126, fault injection component 128, and other components described or suggested by different embodiments described herein, that can improve the operation of system 100. Testing equipment 150 may further include storage device 162. In an example, storage device 162 may provide nonvolatile storage of data, data structures, computer executable instructions, and so forth.

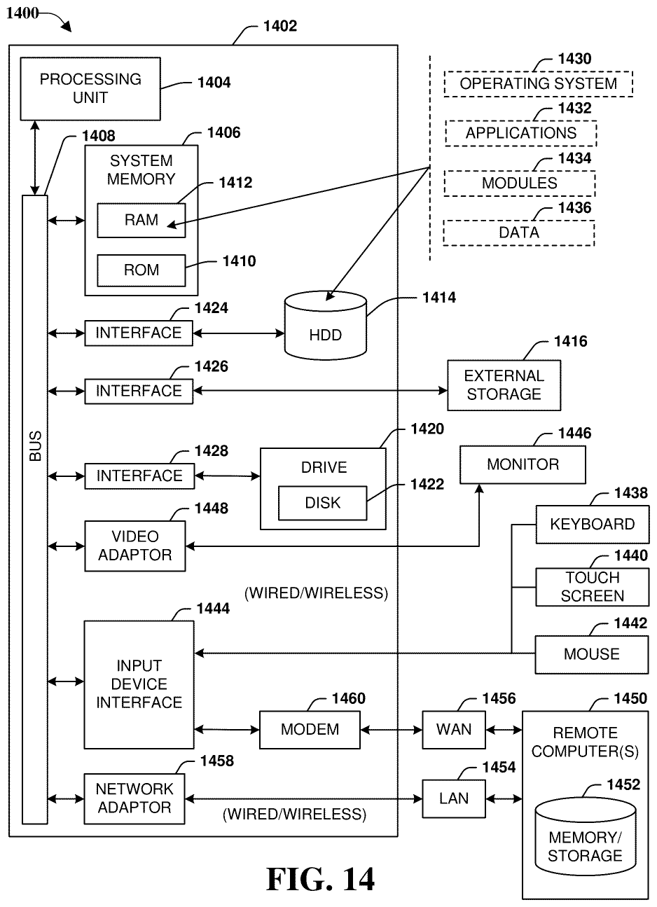

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1404 of FIG. 14. Such examples of processor 160 can be employed to implement any embodiments of the subject disclosure.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1406 and FIG. 14. Such examples of memory 165 can be employed to implement any embodiments of the subject disclosure.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of data component 122, which can in some implementations can receive data from operation of an application system, resulting in received data. For example, in one or more embodiments, data component 122 may receive application data 177 from operation of application 176, resulting in received data.

In another example, memory 165 can store executable instructions that can facilitate generation of scenario component 124, which in some implementations may, based on the received data, identify fault data representative of a fault scenario, with at least one layer of layers of an architecture of the application system being subject to injection of a fault. For example, in one or more embodiments, scenario component 124 can, based on the received data being used to train a model of the operation of application 176 and application equipment 175, identify fault data representative of a fault scenario for application 176, with at least one layer of layers of an architecture of the application system being subject to injection of a fault.

In another example, memory 165 can store executable instructions that can facilitate generation of predicting component 126, which in some implementations may, based on a model of operation of the application system, predict a result of the injection of the fault, resulting in a predicted result. For example, in one or more embodiments, predicting component 126 may, based on a model of operation of the application system, predict a result in the operation of application 176 caused by the injection of the fault, resulting in a predicted result.

In another example, memory 165 can store executable instructions that can facilitate generation of fault injection component 128, which in some implementations may, based on a difference between an actual result of the injection and the predicted result, adjusting the injection of the fault. For example, in one or more embodiments, fault injection component 128 may, based on a difference between an actual result of the injection measured by updated application data 177 and the predicted result from predicting component 126, adjust the injection of the fault.

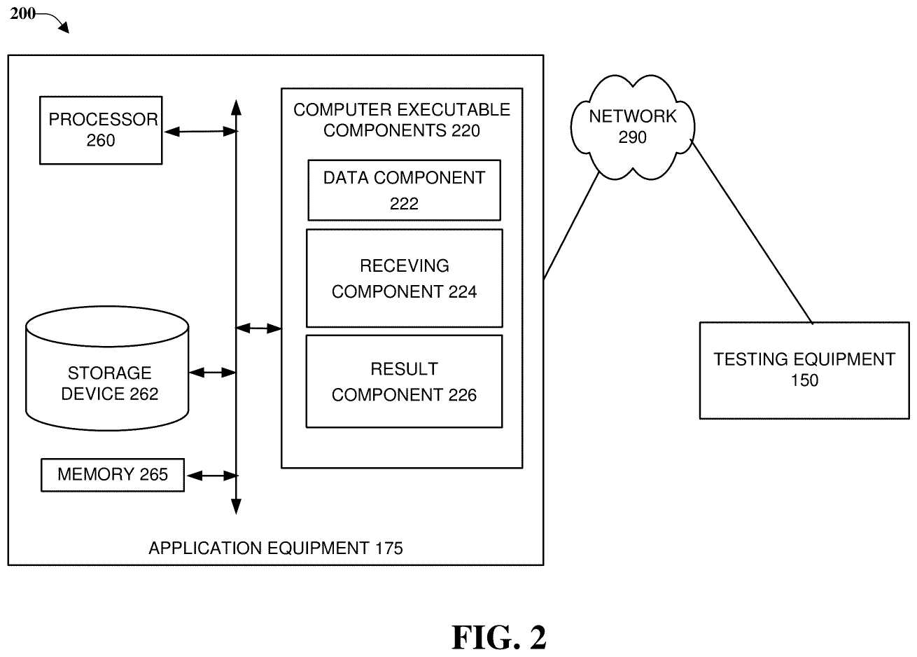

FIG. 2 is an architecture diagram of an example system 200 that can facilitate using a predictive model based on application data to test and monitor application systems, in accordance with one or more embodiments. For purposes of brevity, description of like elements and/or processes employed in other embodiments is omitted. As depicted, system 200 includes application equipment 175 connected, via network 290, to testing equipment 150. Application equipment 175 includes processor 260, memory 265, storage device 262, and computer executable components 220.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include data component 222, receiving component 224, result component 226, and other components described or suggested by different embodiments described herein, e.g., that can improve the operation of system 200, in accordance with one or more embodiments.

As discussed further with FIG. 14 below, network 290 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3× (5G Option 3×), high speed packet access (HSPA), Z-Wave, Zigbee and other 802.XX wireless technologies and/or legacy telecommunication technologies.

In an example implementation of application equipment 175, memory 265 can store executable instructions that can facilitate generation of data component 222, which in some implementations, may communicate, to a testing system, training data, including historical data generated based on an operation of the computing system. For example, in one or more embodiments, data component 222 may communicate to testing equipment 150, application data 177 used to train a model of application 176, including historical data generated based on an operation of application equipment 175.

In an example implementation of application equipment 175, memory 265 can further store executable instructions that can facilitate generation of receiving component 224, which in some implementations, may receive, from the testing system, a test instruction configured to cause an error in an absence of a fault, with the error causing events that occur at a first tier of a tiered infrastructure of the computing system and a second tier of the computing system. For example, in one or more embodiments, receiving component 224 may receive, from the testing system, a test instruction configured to cause an error in an absence of a fault, with the error causing events that occur at a first tier of a tiered infrastructure of the computing system and a second tier of the computing system.

In an example implementation of application equipment 175, memory 265 can further store executable instructions that can facilitate generation of result component 226, which in some implementations, may communicate, to the testing system, result data based on the test instruction. For example, in one or more embodiments, result component 226 may communicate, to the testing system, result data based on the test instruction.

In an example implementation of application equipment 175, result component 226, may further receive, from the testing system, a modified test instruction, with the modified test instruction being based on the training data. For example, in one or more embodiments, result component 226 may further receive, from the testing system, a modified test instruction, with the modified test instruction being based on the training data.

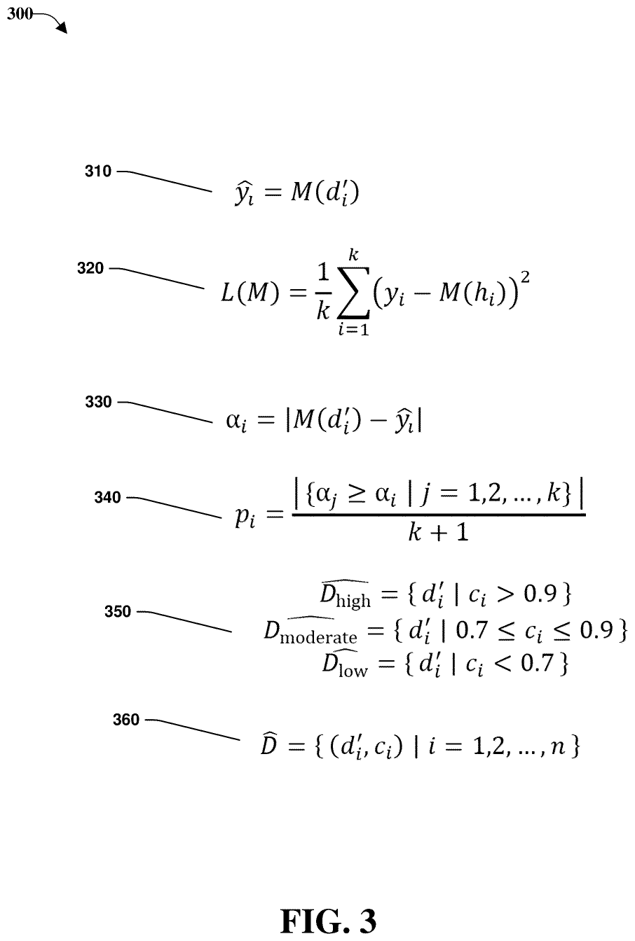

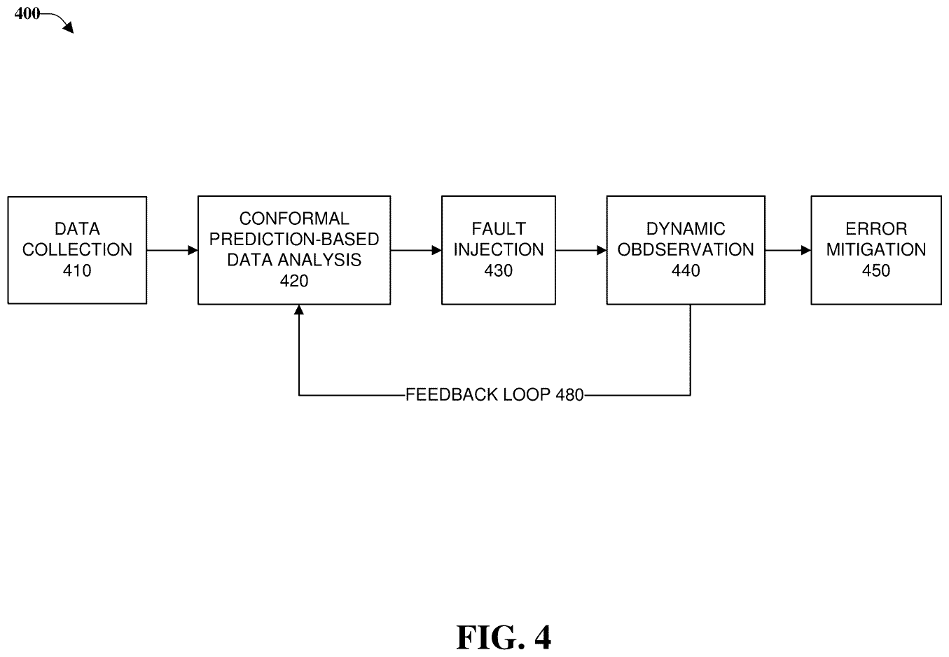

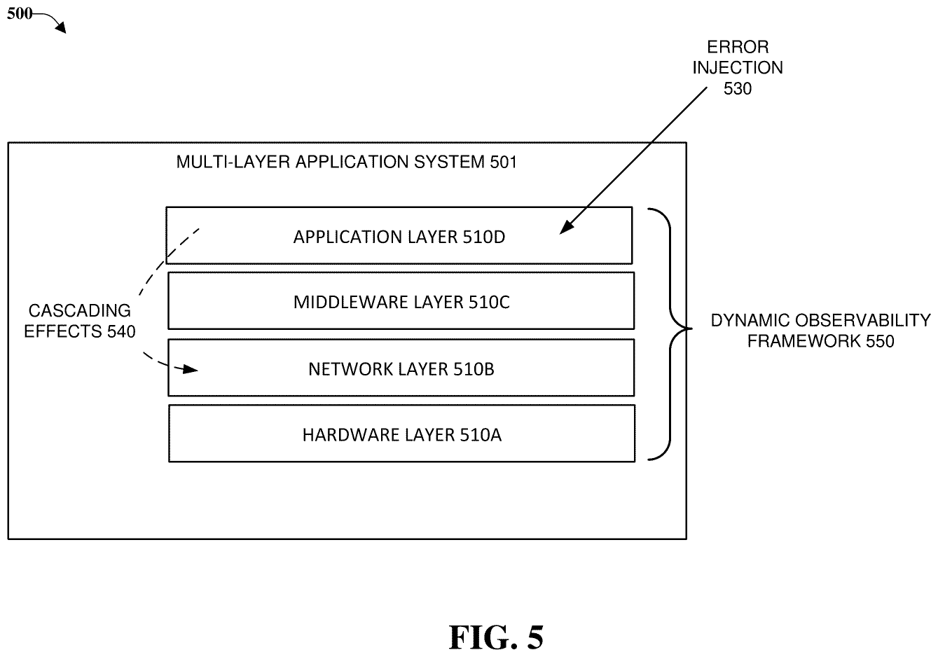

FIG. 3 includes a diagram that illustrates example system 300 that can facilitate using a predictive model to test and monitor application systems, in accordance with one or more embodiments. For purposes of brevity, description of like elements and/or processes employed in other embodiments is omitted. System 300 includes elements 310, 320, 330, 340, and 350 that are described below with the descriptions of FIGS. 4-5 to illustrate one or more of the various example embodiments described herein.

At 320 and 330, training a model of application 176 using data sources discussed herein is described, e.g., generating a predictive function (e.g., M in 320) using a regression method that minimizes a loss function (e.g., L in 330). At 330, a nonconformity score (αᵢ) may be generated that measures how different the collected application data 177 is from historical data used to train the model, and at 340, the nonconformity score may be assigned as a p-value (pᵢ) for data points of collected application data 177.

At 350, the assigned p-values may be used as confidence scores (cᵢ) for the data points which may be categorized with different confidence levels, e.g., labeling application data 177 with confidence levels of high, moderate, and low. At 360, a data set may be generated that may facilitate fault prediction (e.g., by predicting component 126), fault injection (e.g., with scenarios generated by scenario component 124), and mitigation processes (e.g., generated from feedback from fault injection by fault injection component 126) described with FIGS. 4-5 below.

FIG. 4 includes a diagram that illustrates example system 400 that can facilitate using a conformal prediction-drives model to dynamically perform and monitor fault injection testing, in accordance with one or more embodiments. For purposes of brevity, description of like elements and/or processes employed in other embodiments is omitted. System 400 includes different elements of one or more embodiments, including data collection 410, conformal prediction-based data analysis 420, fault injection 430, dynamic observation 440, and error mitigation 450. Feedback loop 480 is labeled, showing data from dynamic observation 440 being used to further perform conformal prediction-based data analysis 420.

At data collection 410, based on collected application data 177, a model of operation application 176 was trained, e.g., based on historical incident data of the application system and historical telemetry data applicable to the application system. In some implementations, at conformal prediction-based data analysis 420, conformal prediction processes may be used to improve testing processes used by embodiments as compared to other approaches. As described herein, conformal prediction may be implemented as a statistical framework that analyzes how well predictions by predicting component 126 conform to a set of previously observed application data. In additional implementations, the received data may be filtered from use by fault injection 430, based on the respective confidence scores, or alternatively, the data may be utilized with the significance of the data being weighted by the applied confidence scores.

At fault injection 430, embodiments may select different injection tests based on conformal prediction, e.g., faults to address scenarios that are not only representative of real-world scenarios, but are also accompanied by probabilistic guarantees may assist in the generation of mitigation strategies for the most probable and dangerous scenarios.

At dynamic observation 440, embodiments may continuously collect telemetry, logs, traces, and performance metrics from various components of the tested application system. In one or more embodiments, the observability system may dynamically adapt based on the active fault scenario, e.g., offering tailored insights with improved reliability. Further, by providing certainty levels for result data collected based on fault injection 430, embodiments may reduce the risk of generating mitigation strategies based on noisy or unreliable information, e.g., enhancing decision-making during incident response and fault localization.

At feedback loop 480, over a testing interval, result data may be fed back to conformal prediction-based data analysis 420 to facilitate adapting fault injection scenarios and observability data collection based on the current state of the tested environment. In some implementations, employing a continuous feedback loop 480 may improve the likelihood that unanticipated effects the of fault injection are identified and analyzed, e.g., by modifying previously generated predictions and data gathering processes. In one or more embodiments, by continuously updating based on real-time conditions, may improve predictive accuracy of the system, and further improve the overall fault management lifecycle.

In an example, based on data collected during dynamic observation 440, after feedback loop 480, fault injection 430 may adjust the injection of the fault by changing fault parameters that include, but are not limited to, an intensity of the fault, a different fault other than the fault, and/or a new combination of the layers of the application system that are implicated by the fault.

FIG. 5 includes a diagram that illustrates example system 500 that can facilitate using a predictive model to test and monitor multiple application layers in a cloud-based system, in accordance with one or more embodiments. For purposes of brevity, description of like elements and/or processes employed in other embodiments is omitted. System 500 includes multi-layer application system 501 and dynamic observability framework 550. Multilayer application system 501 includes layers 510A-D: hardware layer 510A, network layer 510B, middleware layer 510C, and application layer 510D. Error injection 530 shows a fault injection at application layer 510D, and application layer 510D is labeled as cascading effects 540 of the fault injection to network layer 510B. As used herein, layers of a multi-layered system, may also be termed tiers of a tiered infrastructure and services of an interconnected cloud-based system, and architectural layers of a system.

In an example, one or more embodiments may receive log data for an application associated with a cloud-based system (e.g., multi-layer application system 501). Based on the received log data, embodiments may identify a testing plan/scenario with predicted results having at least a threshold likelihood of occurring at the cloud-based system, e.g., based on conformal predictions described with FIG. 4. In this example, the identified scenario includes fault injection at application layer 510D, e.g., error injection 530.

Continuing this example, according to predictions and the identified scenario, dynamic observability framework 550 may monitor one or more of layers 510A-D. In embodiments, predictions and fault scenarios may predict results based on intricate dependencies between services and layers 510A-D. Accordingly, dynamic observability framework 550 may monitor results based on resources allocated to detect predicted effects.

In this example, dynamic observability framework 550 may identify cascading effects 540 in network layer 510B from the error injection 530 at application layer 510D. Based on this identification of effects being used with feedback loop 480, an updated testing plan/scenario may be generated, e.g., that allocates additional resources to monitoring network layer 510B and identifies other potential effects that are related to cascading effects 540 in other layers 510A-D.

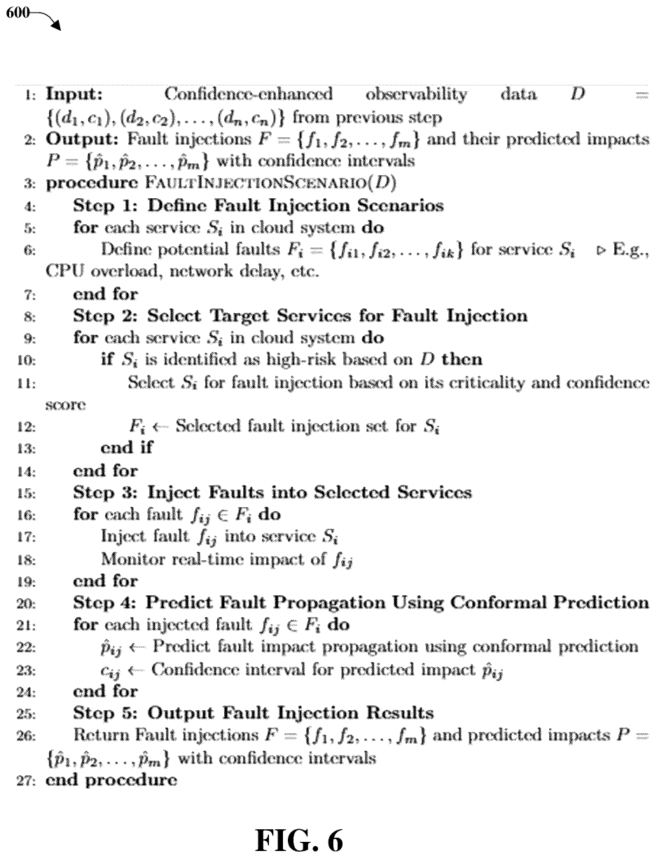

FIG. 6 depicts example pseudocode 600 that can be used by embodiments to use a predictive model to test and monitor application systems, in accordance with one or more embodiments. Repetitive description of like elements employed in one or more embodiments described herein is omitted for sake of brevity. As depicted, pseudocode 600 may be used by embodiments for fault injection (e.g., by fault injection component 128) and scenario definition (e.g., by scenario component 124).

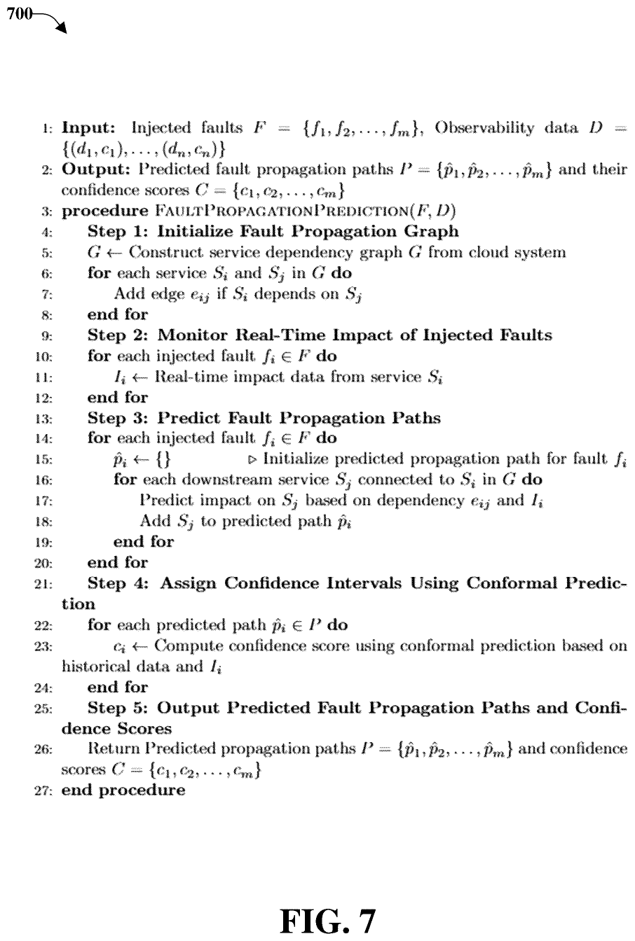

FIG. 7 depicts example pseudocode 700 that can be used by embodiments to use a predictive model to test and monitor application systems, in accordance with one or more embodiments. Repetitive description of like elements employed in one or more embodiments described herein is omitted for sake of brevity. As depicted, pseudocode 700 for use by embodiments for prediction of effects that will result from fault propagation, e.g., by predicting component 126.

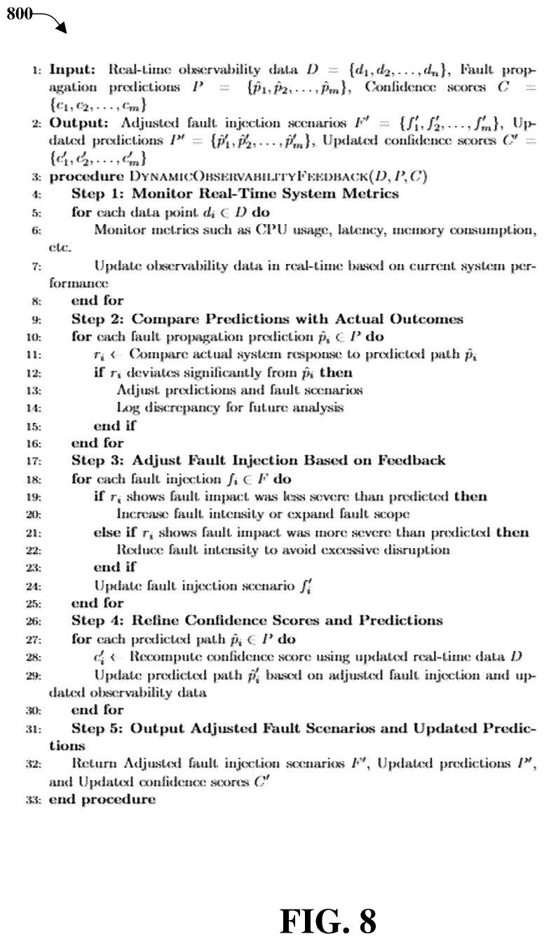

FIG. 8 depicts example pseudocode 800 that can be used by embodiments to use a predictive model to test and monitor application systems, in accordance with one or more embodiments. Repetitive description of like elements employed in one or more embodiments described herein is omitted for sake of brevity. As depicted, pseudocode 800 for use by embodiments to employ the dynamic observability and feedback loop, e.g., by dynamic observation 440 and feedback loop 480.

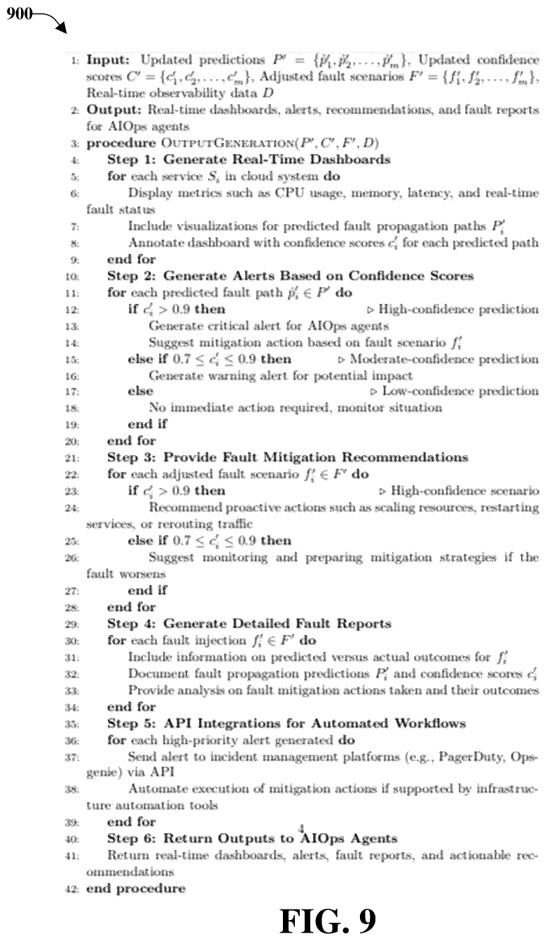

FIG. 9 depicts example pseudocode 900 that can be used by embodiments to use a predictive model to test and monitor application systems, in accordance with one or more embodiments. Repetitive description of like elements employed in one or more embodiments described herein is omitted for sake of brevity. As depicted, pseudocode 900 for use by embodiments for facilitating output generation, e.g., for error mitigation 450.

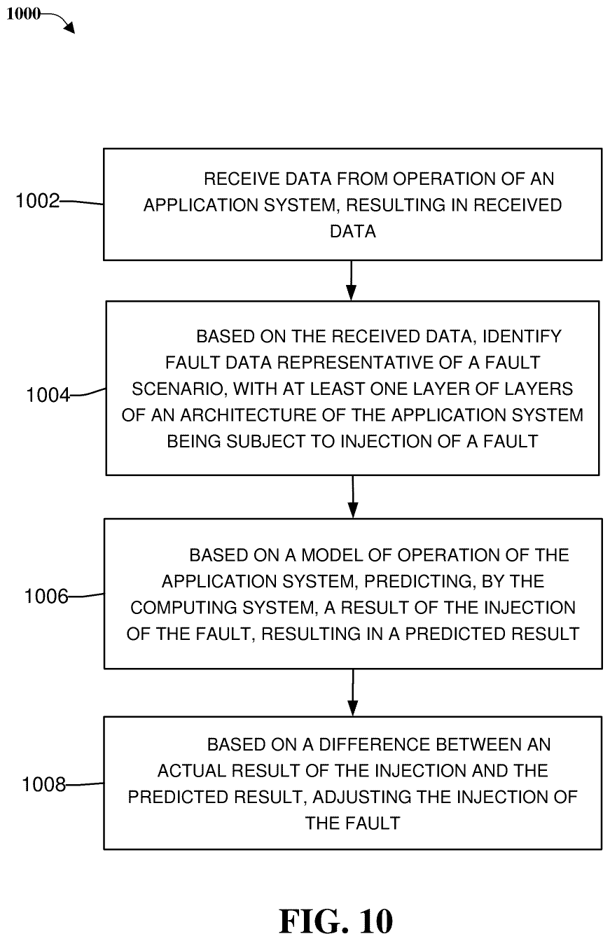

FIG. 10 depicts a flow diagram representing example operations of an example method 1000 that can facilitate using a predictive model to test and monitor application systems, in accordance with one or more embodiments. For purposes of brevity, description of like elements and/or processes employed in other embodiments is omitted.

In some examples, one or more embodiments of method 1000 can be implemented by data component 122, scenario component 124, predicting component 126, fault injection component 128, and other components that can be used to implement one or more parts of method 1000, in accordance with one or more embodiments. FIG. 10, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 1002 of method 1000, data component 122 of testing equipment 150 can receive data from operation of an application system, resulting in received data. At 1004 of method 1000, scenario component 124 can, based on the received data, identify fault data representative of a fault scenario, with at least one layer of layers of an architecture of the application system being subject to injection of a fault. At 1006 of method 1000, predicting component 126 can, based on a model of operation of the application system, predict a result of the injection of the fault, resulting in a predicted result. At 1008 of method 1000, fault injection component 128, can, based on a difference between an actual result of the injection and the predicted result, adjust the injection of the fault.

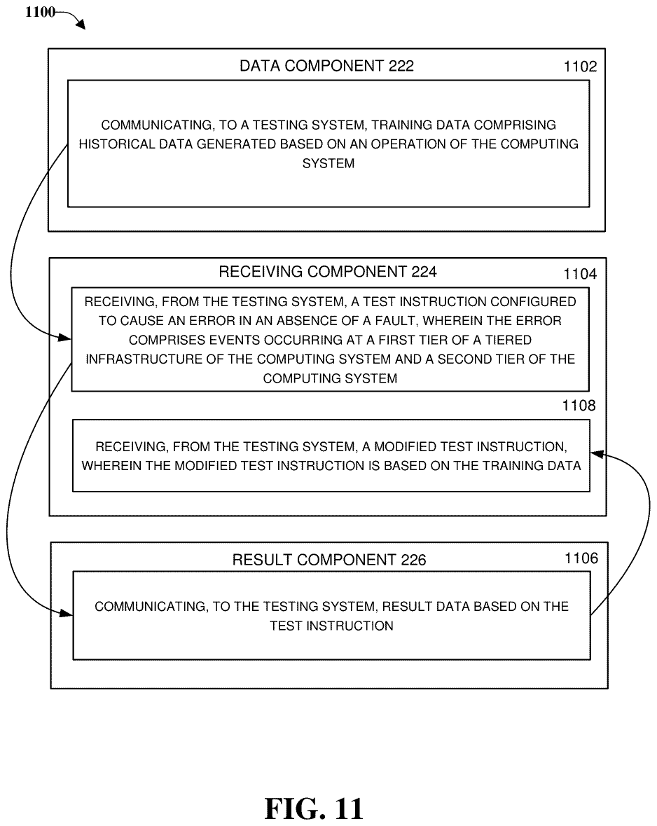

FIG. 11 depicts an example system 1100 that can facilitate using a predictive model to test and monitor application systems, in accordance with one or more embodiments. For purposes of brevity, description of like elements and/or processes employed in other embodiments is omitted.

System 1100 includes at least one memory that stores computer executable components, and at least one processor that executes the computer executable components stored in the at least one memory, with the computer executable components including data component 222, receiving component 224, result component 226, and other components that can be used to implement system 1100, as described herein, in accordance with one or more embodiments.

At 1102 of FIG. 11, data component 222 can communicate, to a testing system, training data including historical data generated based on an operation of the computing system. At 1104 of FIG. 11, receiving component 224 can receive, from the testing system, a test instruction configured to cause an error in an absence of a fault, with the error causing events that occur at a first tier of a tiered infrastructure of the computing system and a second tier of the computing system. At 1106 of FIG. 11, result component 226 can communicate, to the testing system, result data based on the test instruction. At 1108 of FIG. 11, receiving component 224 can further receive, from the testing system, a modified test instruction, with the modified test instruction being based on the training data.

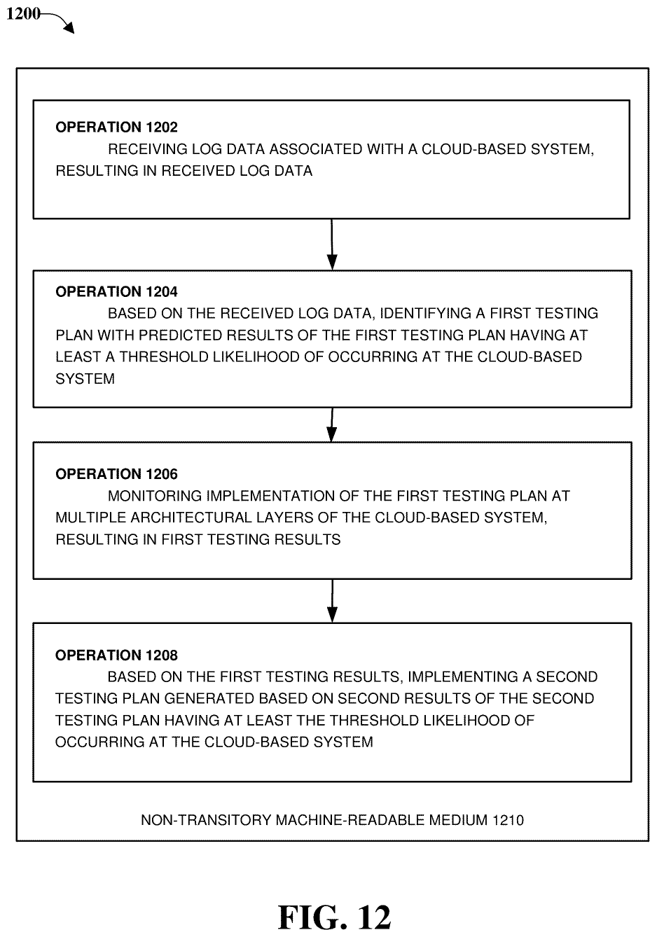

FIG. 12 depicts an example 1200 non-transitory machine-readable medium 1210 that can include executable instructions that, when executed by a processor of a system, can facilitate using a predictive model to test and monitor application systems, in accordance with one or more embodiments. For purposes of brevity, description of like elements and/or processes employed in other embodiments is omitted.

As depicted, non-transitory machine-readable medium 1210 includes executable instructions that, when executed by at least one processor of a computer system, facilitate performance of operations that include operation 1202 which can receive log data associated with a cloud-based system, resulting in received log data. The operations may further include operation 1204 which can, based on the received log data, identify, by the computing system, a first testing plan with predicted results of the first testing plan having at least a threshold likelihood of occurring at the cloud-based system. The operations may further include operation 1206 which can monitor implementation of the first testing plan at multiple architectural layers of the cloud-based system, resulting in first testing results. The operations may further include operation 1208 which can, based on the first testing results, implement a second testing plan generated based on second results of the second testing plan having at least the threshold likelihood of occurring at the cloud-based system.

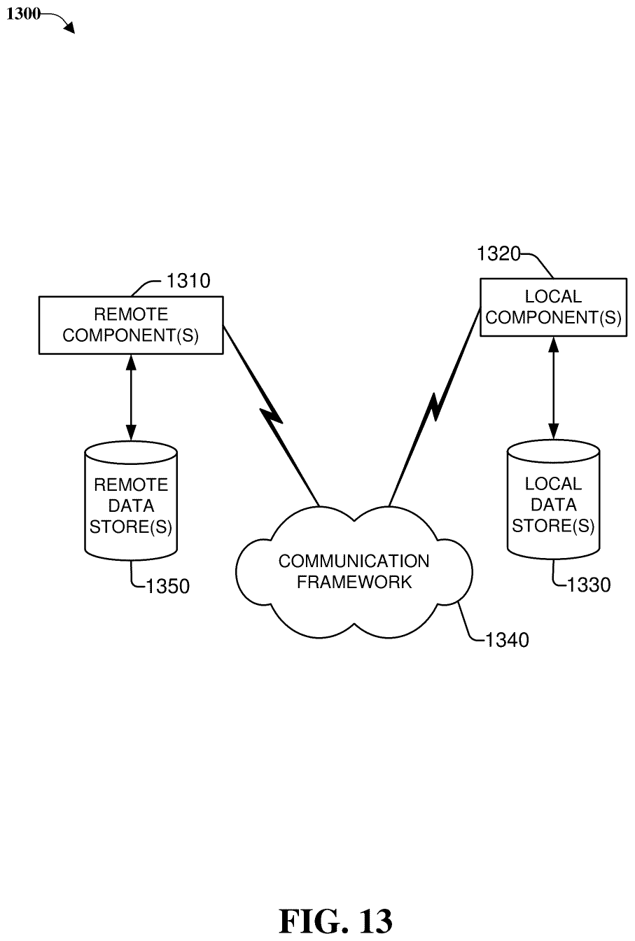

FIG. 13 is a schematic block diagram of a system 1300 with which the disclosed subject matter can interact. The system 1300 comprises one or more remote component(s) 1310. The remote component(s) 1310 can be hardware and/or software (e.g., threads, processes, computing devices). In some embodiments, remote component(s) 1310 can be a distributed computer system, connected to a local automatic scaling component and/or programs that use the resources of a distributed computer system, via communication framework 1340. Communication framework 1340 can comprise wired network devices, wireless network devices, mobile devices, wearable devices, RAN devices, gateway devices, femtocell devices, servers, etc. The system 1300 also comprises one or more local component(s) 1320. The local component(s) 1320 can be hardware and/or software (e.g., threads, processes, computing devices).

One possible communication between a remote component(s) 1310 and a local component(s) 1320 can be in the form of a data packet adapted to be transmitted between two or more computer processes. Another possible communication between a remote component(s) 1310 and a local component(s) 1320 can be in the form of circuit-switched data adapted to be transmitted between two or more computer processes in radio time slots. The system 1300 comprises a communication framework 1340 that can be employed to facilitate communications between the remote component(s) 1310 and the local component(s) 1320, and can comprise an air interface, e.g., Uu interface of a UMTS network, via a long-term evolution (LTE) network, etc. Remote component(s) 1310 can be operably connected to one or more remote data store(s) 1350, such as a hard drive, solid state drive, SIM card, device memory, etc., that can be employed to store information on the remote component(s) 1310 side of communication framework 1340. Similarly, local component(s) 1320 can be operably connected to one or more local data store(s) 1330, that can be employed to store information on the local component(s) 1320 side of communication framework 1340.

In order to provide a context for the various example embodiments of the disclosed subject matter, the following discussion is intended to provide a brief, general description of a suitable environment in which the various example embodiments of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1420 (see below), non-volatile memory 1422 (see below), disk storage 1424 (see below), and memory storage, e.g., local data store(s) 1330 and remote data store(s) 1350, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random-access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated example embodiments can also be practiced in distributed computing environments where tasks are performed by remote processing devices that are linked through a communications network; however, some if not all example embodiments of the subject disclosure can be practiced on stand-alone computers. In a distributed computing environment, program modules can be located in different systems, e.g., both local and remote memory storage devices.

Referring now to FIG. 14, in order to provide additional context for various embodiments described herein, FIG. 14 and the following discussion are intended to provide a brief, general description of a suitable computing environment 1400 in which the various embodiments described herein can be implemented.

While the embodiments have been described above in the general context of computer executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid-state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the . NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can also be connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) RAN or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such features may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by a computing system comprising one or more processors, data from operation of an application system, resulting in received data;
based on the received data, identifying, by the computing system, fault data representative of a fault scenario, wherein at least one layer of layers of an architecture of the application system is subject to injection of a fault;
based on a model of operation of the application system, predicting, by the computing system, a result of the injection of the fault, resulting in a predicted result; and
based on a difference between an actual result of the injection and the predicted result, adjusting, by the computing system, the injection of the fault.

2. The method of claim 1, wherein the model of operation of the application system was trained based on historical incident data of the application system and historical telemetry data applicable to the application system, and wherein the predicting of the result employs conformal prediction of the result.

3. The method of claim 1, wherein the predicted result is associated with a confidence level, and further comprising, based on the confidence level, changing, by the computing system, the injection of the fault resulting in an updated confidence level for the predicted result that is different from the confidence level.

4. The method of claim 1, wherein the model is a first model, and further comprising, based on a second model of operation of the application system, applying, by the computing system, conformal prediction to respective received data received by the computing system, wherein the applying of the conformal prediction comprises generating respective confidence scores for the respective received data, wherein the predicting of the result is further based on a confidence score of the respective confidence scores, and wherein the confidence score is correlated to the predicted result.

5. The method of claim 4, further comprising, based on the respective confidence scores, filtering, by the computing system, the received data from the identifying of the fault data representative of the fault scenario.

6. The method of claim 4, wherein the second model was trained based on historical information comprising normal events and abnormal events of the application system.

7. The method of claim 4, further comprising, based on the respective confidence scores, categorizing the respective received data into different reliability levels.

8. The method of claim 1, wherein the received data was collected from the at least one layer of the layers of the architecture of the application system, and wherein the layers comprise at least one of:
a hardware layer,
a network layer,
an application layer, or
a service layer.

9. The method of claim 1, wherein the predicted result comprises predicted results for multiple layers of the layers of the architecture of the application system.

10. The method of claim 9, wherein the predicted results for the multiple layers comprises an effect at a layer of the multiple layers that was propagated to the layer by another layer of the multiple layers other than the layer.

11. The method of claim 10, wherein propagation of the effect was caused by an interdependency between the layer and the other layer, and wherein the predicted result is further based on the interdependency.

12. The method of claim 9, wherein the injection of the fault comprises a first injection of a first fault at a first layer of the multiple layers, and a second injection of a second fault at a second layer of the multiple layers, and wherein the predicted results comprise effects, to the application system, from occurrence of a combination of the first fault and the second fault.

13. The method of claim 1, wherein the adjusting of the injection of the fault comprises at least one of changing an intensity of the fault, selecting a different fault other than the fault, or selecting a new combination of the layers for the injection of the fault.

14. The method of claim 1, wherein the application system comprises a cloud-based application system.

15. A computing system, comprising:
at least one memory that stores computing executable instructions; and
at least one processor configured to process the computing executable instructions that, when executed by the at least one processor, facilitate performance of operations, comprising:
communicating, to a testing system, training data comprising historical data generated based on an operation of the computing system,
receiving, from the testing system, a test instruction configured to cause an error in an absence of a fault, wherein the error comprises events occurring at a first tier of a tiered infrastructure of the computing system and a second tier of the computing system,
communicating, to the testing system, result data based on the test instruction, and
receiving, from the testing system, a modified test instruction, wherein the modified test instruction is based on the training data.

16. The computing system of claim 15, wherein the modified test instruction is based on a conformal prediction of the result data, and wherein the conformal prediction was generated based on a model that was trained based on the training data.

17. The computing system of claim 16, wherein the modified test instruction was generated based on a confidence level of the conformal prediction, and wherein the confidence level was determined based on the model.

18. The computing system of claim 15, wherein the result data comprises a first event, occurring at the first tier, that is based on a cascading of an effect of a second event caused by the test instruction at the second tier.

19. A non-transitory machine-readable medium comprising executable instructions that, when executed by at least one processor of a computer system, facilitate performance of operations, the operations comprising:
receiving log data associated with a cloud-based system, resulting in received log data;
based on the received log data, identifying a first testing plan with predicted results of the first testing plan having at least a threshold likelihood of occurring at the cloud-based system;
monitoring implementation of the first testing plan at multiple architectural layers of the cloud-based system, resulting in first testing results; and
based on the first testing results, implementing a second testing plan generated based on second results of the second testing plan having at least the threshold likelihood of occurring at the cloud-based system.

20. The non-transitory machine-readable medium of claim 19, wherein the second testing results are based on a monitoring of the implementing of the second testing plan at the multiple architectural layers of the cloud-based system, and wherein the operations further comprise, based on the first testing results and the second testing results, modifying a configuration of the cloud-based system.
